(19) United States
(12) Patent Application Publication
(10) Pub. No.: US 2024/0276997 A1
(43) Pub. Date: Aug. 22, 2024

(54) VAPOR HOLDING DEVICE FOR THE INFUSION OF CONSUMABLES

(71) Applicant: EVAN SIGVALDSEN, BEND, OR (US)

(72) Inventor: EVAN SIGVALDSEN, BEND, OR (US)

(21) Appl. No.: 18/111,728

(22) Filed: Feb. 20, 2023

(51) Int. Cl. A23B 4/052

(52) U.S. Cl. CPC A23B 4/052

(57) ABSTRACT

The invention provides a vapor infusing device that infuses consumables held therein with vapor. More specifically, the device houses both vapor and one or more consumables that can be infused with characteristics of the vapor or altered thereby or otherwise altered to create qualities in a consumable as a result of exposure to the vapor.

### FIELD OF THE INVENTION

The invention provides a vapor infusing device that infuses consumables held therein with vapor. More specifically, the device houses both vapor and one or more consumables that can be infused with characteristics of the vapor or altered thereby or otherwise altered to create qualities in a consumable as a result of exposure to the vapor.

### BACKGROUND OF THE INVENTION

Food service is ancient. The first recorded restaurant is listed as having occurred in Paris during the 18th century by a Parisian chef named Boulanger. Before the advent of the restaurant, however, food had been served to diners for centuries before in homes, manors and inns all across the world.

In at least the last one-hundred years, the presentation of food has begun to rival the taste and quality of prepared food itself. Modern culinary schools prepare today's chefs every bit as much to present culinary items as to prepare them deliciously. Such visual presentation is equally as applicable for drink items as it is for food items.

The enclosed invention herein therefore provides a device that aids in the positive visualization and presentation of consumable items like prepared food and drink. Embodiments herein will further elucidate the invention and all of its variations herein.

### SUMMARY OF THE INVENTION

Accordingly, the invention provides a vapor containing device for the infusion of consumables. It comprises a magnetized base having a substantially flat surface upon which a food or drink item is placeable. It further comprises a vacuous top portion that has a bottom edge connectable to the magnetized base.

The vacuous top portion comprises all of the following: i) a continuous walled portion connected to the bottom edge; ii) a vapor entry portal fitted through a portion of the continuous walled portion; and iii) a top portion connected to the continuous walled portion, the top portion being positioned oppositely to the bottom edge. The vacuous top portion also comprises a volume, and a handle fixed about the center of the top portion of the vacuous top portion by which the vacuous top portion can be removed from the magnetized base. Alternatively, the vapor entry portal can also be positioned onto the top portion of the vacuous top portion.

In practice, vapor is pushed into the vapor containing device by a vapor blowing device that is connectable to the vacuous top portion whereby the vapor blowing device blows vapor into the vacuous top portion. Ideally, the vapor containing device and the vapor blowing device are connected by a hose of common construction.

In practice, the vacuous top portion and the magnetized base are securable to one-another by a combination of one or more magnets in the base and one or more ferrous materials positioned about the bottom edge of the vacuous top portion. Preferably, the bottom edge of the vacuous top portion is at least partially ferrous. It could also be substantially or fully ferrous as well.

A preferred execution of the vapor containing device comprises a vacuous top portion that is a substantially clear, see-through material (i.e., transparent). This is for presentation purposes. Ideally, the clear, see-through material is one of the well-known kinds of transparent acrylic or similar polyethyl materials.

The vapor provided herein can impact or alter a consumable exposed thereto. In one embodiment herein, consumables exposed to the vapor herein are altered thereby. For example, an altered consumable herein may be altered by the vapor herein according to taste. The vapor herein may also be structured to alter the composition of a consumable exposed thereto. An altered consumable herein can also be altered for composition. Still further, an altered consumable herein can be altered for texture. It is also true that a vapor altered consumable herein can be altered for smell.

A vapor used herein can provide a visual signal to a user of taste, texture, composition, smell, readiness and more. In such signaling, the vapor can exhibit at least one color. In another embodiment herein, the vapor can exhibit two or more colors (i.e., either two or more colors together or changing from color to another in sequence). In an alternative embodiment herein in which the vapor changes colors due, for example, to its interaction with one or more consumables, that color change can happen over time signaling a gradual change in the consumable itself.

### BRIEF DESCRIPTION OF THE FIGURES

The various exemplary embodiments of the present invention, which will become more apparent as the description proceeds, are described in the following detailed description in conjunction with the accompanying drawings, in which:

FIG. 1 is an isometric view of the inventive embodiment herein; and

FIG. 2 is an exploded isometric view of the inventive embodiment of FIG. 1.

### DETAILED DESCRIPTION OF THE INVENTION

The following description is provided as an enabling teaching of the present inventive device in its best, currently known aspect. To this end, those skilled in the relevant art will recognize and appreciate that many changes can be made to the various aspects of the inventive device described herein, while still obtaining the beneficial results of the present disclosure. It will also be apparent that some of the desired benefits of the present disclosure can be obtained by selecting some of the features of the present disclosure without utilizing other features.

Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to “an element” can include two or more such elements unless the context indicates otherwise.

As used herein, the terms “optional” or “optionally” mean that the subsequently described event or circumstance can or cannot occur, and that the description includes instances where an event or circumstance occurs and instances where it does not.

The word “or” as used herein means any one member of a particular list and also includes any combination of members of that list. Further, one should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

Disclosed are components that can be used to make or use the enclosed invention. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein. This applies to all aspects of this application including.

By the term “vapor” it is meant herein a gas, gaseous substance, and/or smoke having particulate matter therein.

By the term “consumable” or “consumables” it is meant herein any one of the liquid, solid or semi-solid substances fit for human consumption which are not poisonous to humans.

As has been noted hereinabove, the enclosed invention provides for the infusion of consumables. It has a magnetized base having a substantially flat surface upon which a food and/or drink item may be placed. It further comprises a vacuous top portion that has a bottom edge connectable to the magnetized base.

The vacuous top portion comprises all of the following: i) a continuous walled portion connected to the bottom edge; ii) a vapor entry portal fitted through a portion of the continuous walled portion; and iii) a top portion connected to the continuous walled portion, the top portion being positioned oppositely to the bottom edge. The vacuous top portion also comprises a volume (i.e., an empty space), and a handle fixed about the center of the top portion of the vacuous top portion by which the vacuous top portion can be removed from the magnetized base.

Vapor, as defined herein, is pushed into the vapor containing device by a vapor blowing device that is connectable to the vacuous top portion whereby the vapor blowing device blows vapor into the vacuous top portion. Ideally, the vapor containing device and the vapor blowing device are connected by a hose of common construction.

The vapor blowing device, though important to the functioning of the vapor containing device herein, itself does not serve to limit the description of the invention or any of its embodiments. Small and/or portable air compressors are suitable for use as blowers of vapor into the vapor containing device and are well known by persons of skill in the art.

In practice, the vacuous top portion and the magnetized base are securable to one-another by a combination of one or more magnets in the base and one or more ferrous materials positioned about the bottom edge of the vacuous top portion. Preferably, the bottom edge of the vacuous top portion is ferrous.

A preferred execution of the vapor containing device comprises a vacuous top portion that is a substantially clear, see-through material. This is for presentation purposes. Ideally, the clear, see-through material is one of the kinds of transparent acrylic.

The vapor provided herein can impact or alter a consumable exposed thereto. In one embodiment herein, consumables exposed to the vapor herein are altered thereby. For example, an altered consumable herein may be altered by an infusing vapor herein to change taste. The vapor herein may also be structured to alter the composition of a consumable exposed thereto. An altered consumable herein can also be altered for composition. Still further, an altered consumable herein can be altered for texture. It is also true that a vapor altered consumable herein can be altered for smell.

A vapor for the proscribed invention herein can provide a visual signal to a user for taste, texture, composition, readiness and more. In such signaling, the vapor may exhibit at least one color. In another embodiment herein, the vapor can exhibit two or more colors. In an alternative embodiment herein in which the vapor changes colors due, for example, to its interaction with consumables, that color change can happen over time rapidly or gradually.

As has been noted hereinabove, “vapor” as used herein can either be a gas, gaseous substance, and/or smoke having particulate matter therein. In one instance herein, the vapor is gaseous and does not contain, substantially, any particulates especially from a previously burned material. In another instance herein, the vapor is smoke or a smokey gaseous substance containing particulate matter.

By the term “smoke” it is meant herein a visible suspension of carbon or other particles in air, typically one emitted from a burning substance like charcoal, wood and the like.

Whether gaseous or smokey (i.e., smoke), the vapor provided herein can be designed to interact with a consumable (i.e., food and/or drink) to create a visual effect in a consumable, change in composition, change in flavor, change in smell and/or change in taste.

A vapor herein may cause a visual effect in a consumable, for example, changing a dark liquid into clear or clear liquid into dark. Ideally, such a transformation would occur in the presence of a consumer (e.g., a restaurant diner) to cause wonder and delight as the liquid is served to the consumer.

A vapor may also be used herein as a final (or additional) ingredient that changes a food's composition particularly as it relates to taste, smell or texture. Such a transformation could constitute a controlled chemical reaction that is presentable to a consumer at the time of serving. The choice of transformation type is a design choice and itself does not limit the capabilities of the invention herein.

The structure of the vapor containing device can itself be used to enable a transformation in a consumable. For example, the inside of the vacuous top portion may be coated with a reactive material that reacts in the presence of a kind of vapor thereby causing a change in the vapor and/or consumable impacted by the vapor.

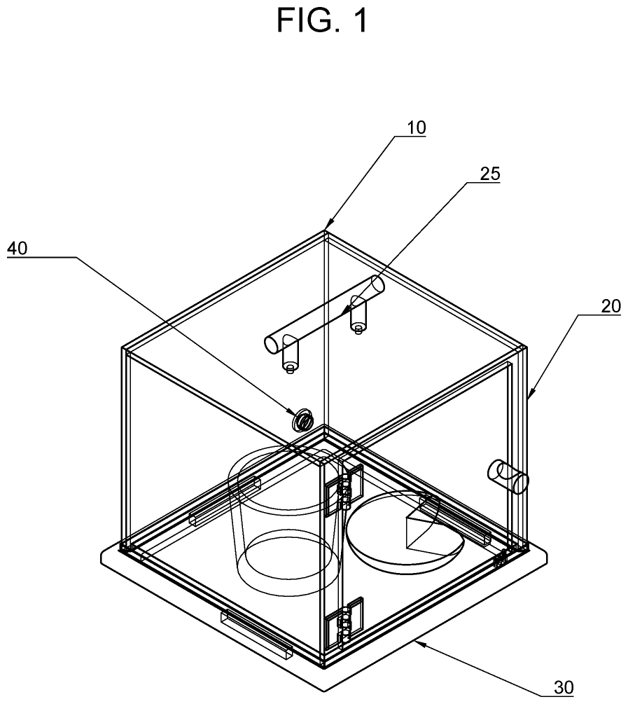

FIG. 1 is an isometric view of the inventive embodiment herein. Shown herein is vapor containing device 10 (or “device 10”). Comprised thereof are vacuous top portion 20, magnetized base 30 and vapor entry portal 40. Vacuous top portion 20 sits fittedly upon magnetized base 30 and mates thereto by one or more magnets (not shown) in magnetized base 30 and one or more ferrous materials 45 that line the bottom lip of vacuous top portion 20. By the term “fittedly” it is meant herein that top portion 20 and magnetized base 30 are made to fit securely, one on the top the other in a neat, fitting manner.

The magnets in magnetized base 30 may be a group of magnets or one continuous magnet formed into magnetized base 30. Such magnets are well known by persons of skill in the prior art. As currently constructed, the magnet or magnets are in magnetized base 30 and the ferrous material lines the rim of vacuous top portion 20. In an alternative embodiment herein, the magnets can be fit about the rim of vacuous top portion 20 and the ferrous material may be placed about base 30.

In practice, vacuous top portion 20 must be forcibly pulled, albeit lightly, from magnetized base 30. The force necessary to separate vacuous top portion 20 from magnetized base 30 can vary by manufacturer design choice but in no event should such force be more than necessary for a medium sized child to separate the two parts from one-another.

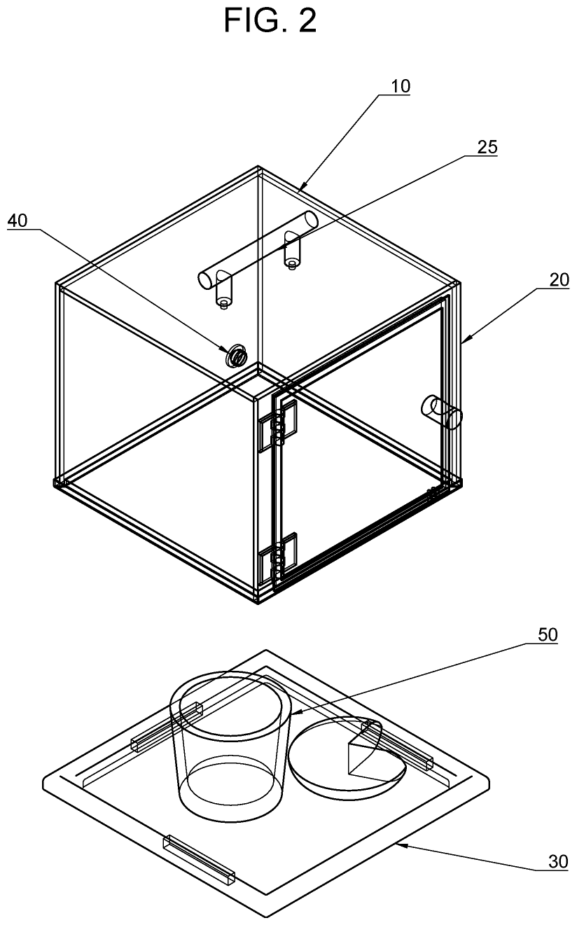

FIG. 2 is an exploded perspective view of the inventive embodiment of FIG. 1. It displays vapor containing device 10 having vacuous top portion 20, magnetized base 30, vapor entry portal 40 and consumables 50. Also shown is vacuous top portion 20 pulled apart from magnetized base 30. As has been noted hereinabove, such separation of the two parts should be able to be accomplished by a medium sized child; i.e., the maximum force required to achieve.

Obviously, once pulled away, vacuous top portion 20 should preferably be held by handle 25. When pulled away, vacuous top portion 20 reveals not only the infused consumables but also the released vapor (i.e., vapor or smoke) housed inside thereof. The effect of such release can provide additional dramatic presentation to diners in a restaurant setting, dinner party, banquet and the like.

By the term “infused consumables” or “infused consumable” it is meant herein consumables 50 to which the vapor herein directly contacts such consumables 50 within vacuous top portion 20. Infused consumables are not necessarily literally infused (i.e., take on the quality of) with the qualities of the vapor provided by device 10 through a hose connected to vapor entry portal 40.

Examples of consumables that can be infused with vapor or “smoked” herein are all of the following: alcoholic beverages; meats; vegetables; cheeses; fruits; juices, and the like which are consumable by mammals, and principally humans. Such smoking can provide a mere visual aesthetic but may also confer taste, smell and/or texture.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A vapor containing infusion device for the infusion of consumables, comprising:
a. A magnetized base having a substantially flat surface upon which a consumable item is placeable;
b. A vacuous top portion having a bottom edge connectable to said magnetized base, and having
i. a continuous walled portion connected to said bottom edge,
ii. a vapor entry portal fitted through a portion of said vacuous top portion; and
iii. a top portion connected to said continuous walled portion, said top portion being positioned oppositely to said bottom edge, said vacuous top portion having a volume; and
c. A handle fixed about said center of said top portion of said vacuous top portion.

2. The vapor containing infusion device of claim 1 wherein a vapor blowing device is connectable to said vacuous top portion whereby said vapor blowing device blows vapor into said vacuous top portion through said vapor entry portal.

3. The vapor containing infusion device of claim 1 wherein said bottom edge of said vacuous top portion is ferrous.

4. The vapor containing infusion device of claim 1 wherein said vacuous top portion is transparent.

5. The vapor containing infusion device of claim 4 wherein said vacuous top portion substantially comprises a clear, see-through material.

6. The vapor containing infusion device of claim 5 wherein said clear, see-through material is transparent acrylic.

7. The vapor containing infusion device of claim 1 wherein said consumables are altered by said vapor.

8. The vapor containing device of claim 7 wherein said altered consumables by said vapor are altered for taste.

9. The vapor containing infusion device of claim 7 wherein said altered consumables of said vapor are altered for composition.

10. The vapor containing infusion device of claim 7 wherein said altered consumables of said vapor are altered for texture.

11. The vapor containing infusion device of claim 7 wherein said altered consumables of said vapor are altered for smell.

12. The vapor containing infusion device of claim 7 wherein said vapor provides a visual signal.

13. The vapor containing infusion device of claim 12 wherein said vapor exhibits at least one color.

14. The vapor containing infusion device of claim 13 wherein said vapor exhibits two or more colors.

15. The vapor containing infusion device of claim 14 wherein said color in said vapor changes over time.
